(19) United States
(12) Patent Application Publication
(10) Pub. No.: US 2023/0166577 A1
(43) Pub. Date: Jun. 1, 2023

(54) AIR CONDITIONER FOR VEHICLE

(71) Applicant: Hanon Systems, Daejeon (KR)

(72) Inventors: Soo Byeong NAM, Daejeon (KR); Seong Seok HAN, Daejeon (KR); Ki Jung PARK, Daejeon (KR); Kyung Ju AN, Daejeon (KR); Jae Kyun KIM, Daejeon (KR); Jung Won CHO, Daejeon (KR)

(21) Appl. No.: 17/922,105

(22) PCT Filed: May 20, 2021
(86) PCT No.: PCT/KR2021/006268

§ 371 Date: Oct. 28, 2022

(30) Foreign Application Priority Data
May 20, 2020 (KR) 10-2020-0060518
May 20, 2021 (KR) 10-2021-0064599

(51) Int. Cl. B60H 1/00

(52) U.S. Cl. CPC B60H 1/00471; B60H 1/00564

(57) ABSTRACT

Air conditioner for vehicle, small and having two independent air flow paths, controlling air volume independently for each air flow path, and can remove noise while regulating the air volume corresponding to the desired flow path through means for returning flowing air toward a suction port. The air conditioner for vehicle comprises a blower having a plurality of blower wheels, and one blower motor for driving the plurality of blower wheels with the same force, a plurality of inlet flow paths allowing an air inflow port to communicate with a blower inlet, and a return flow path which has a plurality of outlet flow paths allowing a blower outlet to communicate with an air discharge port, which returns, to the blower inlet, at least a part of the air discharged from the blower outlet so that the air volumes discharged from the plurality of air discharge ports are regulated differently.

### TECHNICAL FIELD

The present invention relates to an air conditioner for a vehicle, and more particularly, to an air conditioner for a vehicle, which can remove noise and independently control air volume and temperature in a small-sized independent air conditioner.

### BACKGROUND ART

An air conditioner for a vehicle is a car part, which is installed in a vehicle for the purpose of cooling or heating the interior of the vehicle in the summer season or the winter season or removing frost from a windshield in the rainy season or the winter season to thereby secure a driver's front and rear visual fields. Such an air conditioner typically includes a heating device and a cooling device together, so that it can heat, cool or ventilate the interior of the vehicle through the steps of selectively introducing the indoor air or the outdoor air into the air conditioner, heating or cooling the introduced air, and blowing the heated or cooled air into the vehicle.

Such air conditioners have been developed in various forms according to vehicle types or specifications in the same vehicle type. The front seat space is cooled and heated by a front seat air conditioner, and the rear seat space is cooled and heated by a rear seat air conditioner installed in the console side.

Referring to FIG. 1, in a conventional rear seat air conditioner 2, a connection duct 20 for supplying air discharged from the front seat air conditioner 1 to the rear seat is disposed by being divided into right and left sides. The front seat air conditioner 1 includes a blowing module 5 at one side of an air conditioning case 10, and an inner flow path of the air conditioning case 10 is partitioned into right and left sides by a separator 18. A distribution door 6 is disposed in a front flow path 3 of the separator 18 to control air volume of the right and left flow paths.

An evaporator 11 and a heater core 12 are sequentially provided in the flow path of the air conditioning case 10. A temperature door 15 is provided between the evaporator 11 and the heater core 12 to adjust amounts of cold air and hot air. The rear seat air conditioner 2 includes blowers 23 having fans respectively mounted at the right and left flow paths so as to independently control wind directions and temperatures of four zones including right and left sides of the rear seat. The blower 23 is rotated by a blower motor 22.

The conventional rear seat air conditioner does not have a function of circulating air. Accordingly, the conventional rear seat air conditioner cannot independently control the air volumes of the right and left sides since discharging the same air volume from the right and left sides by the rotation of the blower motor. In order to solve the above problem, an outlet of one door may be blocked to reduce the air volume of a desired side among the right and left sides. However, in a case in which the air volume is blocked artificially as described above, noise is generated inside the vehicle.

### DISCLOSURE

### Technical Problem

Accordingly, the present invention has been made in view of the above-mentioned problems occurring in the related art, and it is an object of the present invention to provide an air conditioner for a vehicle, which can independently control air volumes of air flow paths in a small-sized air conditioner having two independent air flow paths, and can remove noise while controlling the air volume of a desired flow path through a means for returning air to a suction port.

### Technical Solution

To accomplish the above-mentioned objects, according to the present invention, there is provided an air conditioner for a vehicle including: a blower having a plurality of blower wheels and a blower motor for driving the plurality of blower wheels with the same power; a plurality of inlet flow paths for connecting an air inflow port and a blower inlet with each other; a plurality of outlet flow paths for connecting a blower outlet and an air discharge port with each other; and a return flow path for returning at least a portion of the air discharged from the blower outlet to the blower inlet.

Moreover, a return air volume control door for adjusting the air volume of the blower outlet supplied to the return flow path is disposed.

Furthermore, the return flow path is disposed at the side of the blower inlet close to a cut-off region of a scroll case, and is formed in a region that is not overlapped with the cut-off region.

Additionally, the scroll case on the side of the inlet flow path is larger in area and height than the scroll case on the side of the return flow path.

In addition, stepped portions for guiding air to the blower unit are respectively formed in the inlet flow path and the return flow path.

Moreover, the stepped portion is formed between the heights of the scroll case.

Furthermore, the stepped portion is formed in the middle of the height of the scroll case.

Additionally, the height of the scroll case on the side of the return flow path is formed to be lower than an end of an inlet ring of the blower inlet and is gradually increased in an air flow direction.

In addition, a communication portion for connecting the blower outlet and the return flow path, and an area of the communicating portion is smaller than that of the air discharge port.

Moreover, the return air volume control door opens and closes the communication portion, and also opens and closes the air discharge port.

Furthermore, the return air volume control door partially closes the air discharge port so that a portion of the air is always discharged through the air discharge port.

Additionally, the air inflow port is connected to a front seat main air conditioner to increase the volume of the air discharged to the rear seat of the vehicle.

In addition, the air inflow port is formed on the side of the blower inlet, and the inlet flow path includes a portion of the height of the scroll case.

### Advantageous Effects

The air conditioner for a vehicle according to the present invention is a small-sized air conditioner having two independent air flow paths, and includes an air circulation door which is adjustable in a direction that a user wants to control the air volume, thereby discharging a desired air volume and removing noise generated when the air volume is controlled artificially.

### BRIEF DESCRIPTION OF THE DRAWINGS

FIG. 1 is a cross-sectional view of a conventional air conditioner for a vehicle.

FIG. 2 is a perspective view illustrating an air conditioner for a vehicle according to a first embodiment of the present invention;

FIG. 3 is a perspective view illustrating a blower according to the first embodiment of the present invention.

FIG. 4 is a view illustrating an air flow of the air conditioner for a vehicle according to the first embodiment of the present invention.

FIGS. 5 and 6 are cross-sectional views taken along the line A-A of FIG. 2.

FIG. 7 is a perspective view illustrating an air conditioner for a vehicle according to a second embodiment of the present invention.

FIG. 8 is a cross-sectional view taken along the line B-B of FIG. 7.

FIG. 9 schematically illustrates the internal configuration of FIG. 8.

FIGS. 10 and 11 are views illustrating an operational example of FIG. 9.

FIG. 12 is a side cross-sectional view of an air conditioner for a vehicle according to the second embodiment of the present invention.

FIG. 13 is a partially cutaway perspective view illustrating the inside of the air conditioner for a vehicle according to the second embodiment of the present invention.

FIGS. 14 and 15 are partial cross-sectional views illustrating the inside of the air conditioner for a vehicle according to the second embodiment of the present invention.

FIG. 16 is a cutaway perspective view of the air conditioner for a vehicle according to the second embodiment of the present invention.

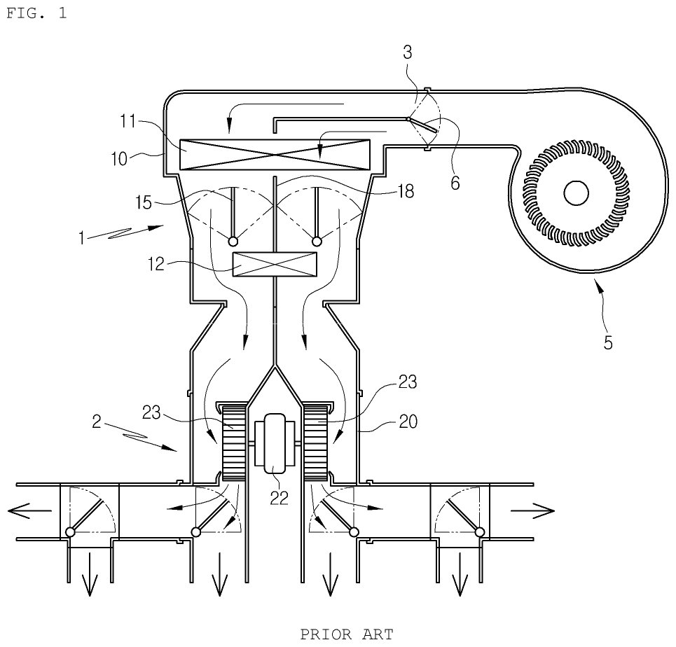

### MODE FOR INVENTION

Hereinafter, the technical configuration of an air conditioner for a vehicle will be described in detail with reference to the accompanying drawings.

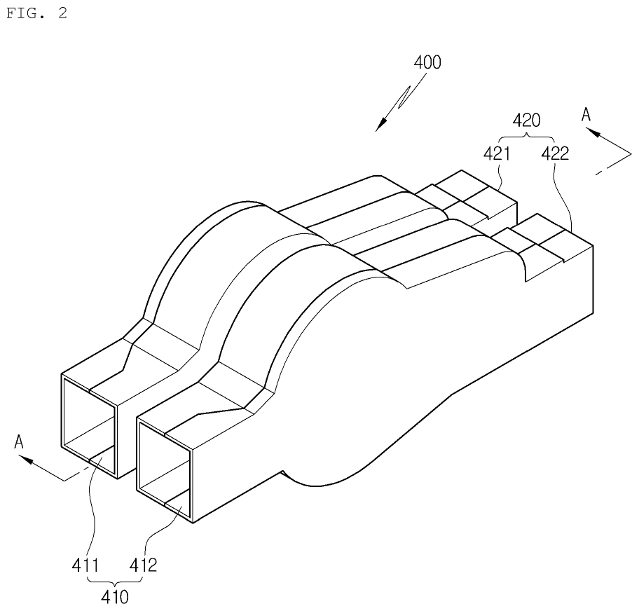

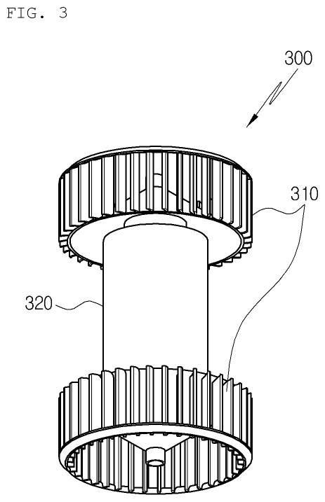

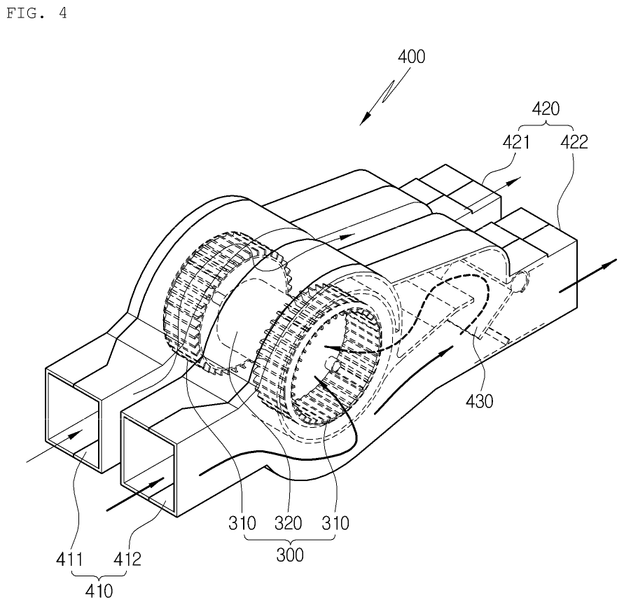

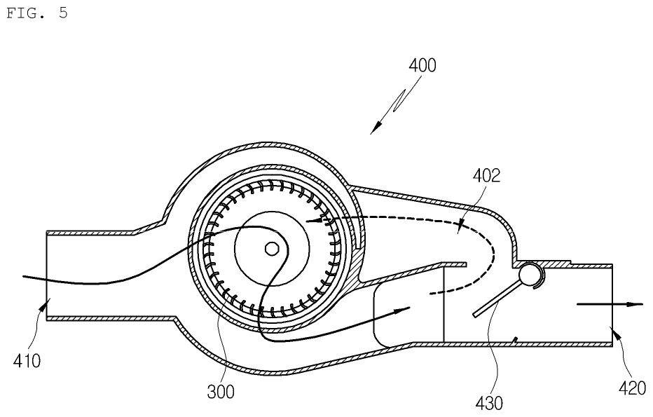

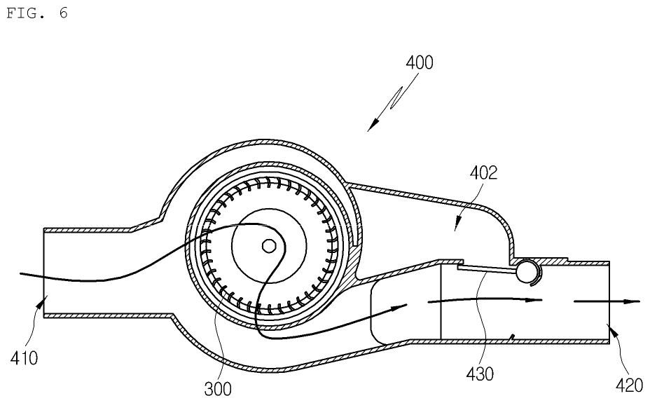

Referring to FIGS. 2 to 6, an air conditioner 400 for a vehicle according to an embodiment of the present invention includes a case and a blower 300. The blower 300 includes a plurality of blower wheels 310 and a blower motor 320, and is mounted at the center of the inside of the case. The blower motor 320 provides power for rotating the blower wheels 310, and one blower motor 320 drives the plurality of blower wheels 310 with the same power.

In addition, the blower motor 320 includes rotary shafts extending to both sides, and the pair of blower wheels 310 are respectively coupled to both rotary shafts of the blower motor 320. The case has two partitioned air flow paths therein, and the pair of blower wheels 310 are respectively disposed in the air flow paths. Furthermore, since one blower motor 320 rotates the two blower wheels 310 with the same power (revolutions per minute), air volumes of the two air flow paths in the case are controlled equally.

The case includes a plurality of air inflow ports 410 formed in one side thereof and a plurality of air discharge ports 420 formed in the other side thereof. The air inflow ports include a first inflow port 411 and a second inflow port 412, and the air discharge ports 420 include a first discharge port 421 and a second discharge port 422. The case includes a plurality of inlet flow paths formed therein to connect the air inflow ports 410 and a blower inlet with each other and a plurality of outlet flow paths formed therein to connect a blower outlet and the air discharge ports 420 with each other.

Moreover, the case further includes a return flow path 402 formed therein. The return flow path 402 returns at least a portion of the air discharged from the blower outlet to the blower inlet so that the air volume discharged from the plurality of air discharge ports 420 can be adjusted differently. Additionally, the case includes a return air volume control door 430 disposed therein. The return air volume control door 430 adjusts the air volume of the blower outlet supplied to the return flow path 402.

Since the blower wheel 310 is driven by the single blower motor 320, both air paths of the vehicle air conditioner 400 discharge the same air volume. In order to reduce the air volume of a desired direction, the air conditioner must block the air discharge port of a desired side or partially block the air discharge ports. However, as described above, in a case in which the air volume is blocked artificially, there is a problem of generating noise from the inside of the air conditioner. The return flow path 402 and the return air volume control door 430 circulate some or all of the air discharged to the air discharge port 420 toward the blower 300 in order to solve the problem.

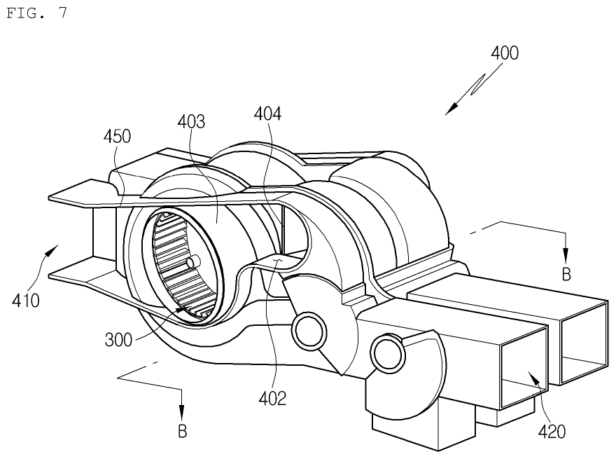

Meanwhile, referring to FIGS. 7 to 16, the air conditioner 400 for a vehicle according to another embodiment of the present invention includes a case 450 and a blower 300. The blower 300 includes a plurality of blower wheels 310 and a blower motor 320, and is mounted at the center of the inside of the case. The blower motor 320 provides power for rotating the blower wheels 310, and one blower motor 320 drives the plurality of blower wheels 310 with the same power.

In addition, the blower motor 320 includes rotary shafts extending to both sides, and the pair of blower wheels 310 are respectively coupled to both rotary shafts of the blower motor 320. The case has two partitioned air flow paths therein, and the pair of blower wheels 310 are respectively disposed in the air flow paths. Furthermore, since one blower motor 320 rotates the two blower wheels 310 with the same power (revolutions per minute), air volumes of the two air flow paths in the case 450 are controlled equally.

The case 450 includes a plurality of air inflow ports 410 formed in one side thereof and a plurality of air discharge ports 420 formed in the other side thereof. The air inflow ports include a first inflow port 411 and a second inflow port 412, and the air discharge ports 420 include a first discharge port 421 and a second discharge port 422. The case 450 includes a plurality of inlet flow paths 405 and a plurality of outlet flow paths 406 formed therein. The inlet flow paths 405 connect the air inflow ports 410 and a blower inlet 331 with each other, and the outlet flow paths connect a blower outlet and the air discharge ports 420 with each other.

Moreover, the case 450 further includes a return flow path 402 formed therein. The return flow path 402 returns at least a portion of the air discharged from the blower outlet to the blower inlet so that the air volume discharged from the plurality of air discharge ports 420 can be adjusted differently. Additionally, the case 450 includes a return air volume control door 430 disposed therein. The return air volume control door 430 adjusts the air volume of the blower outlet supplied to the return flow path 402, namely, the air volume of the outlet flow paths 406.

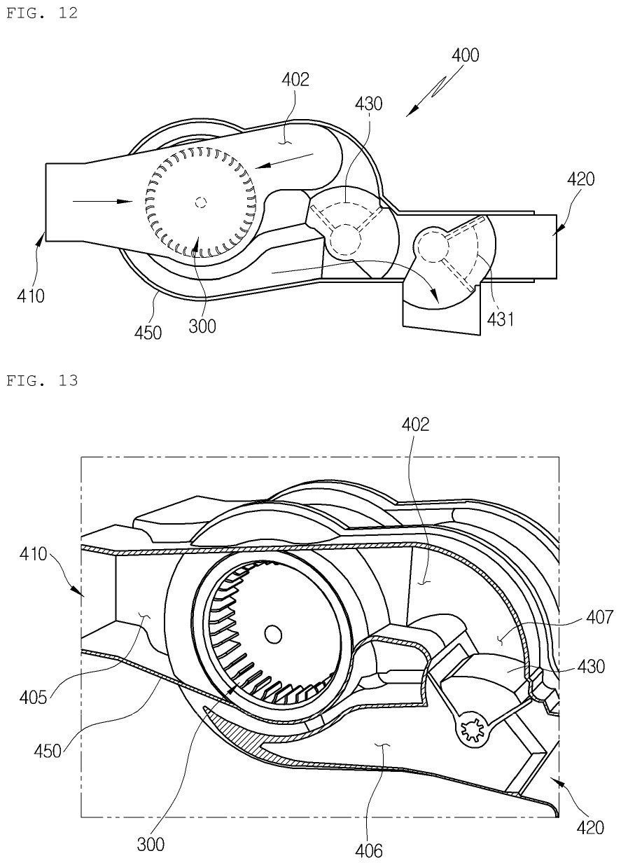

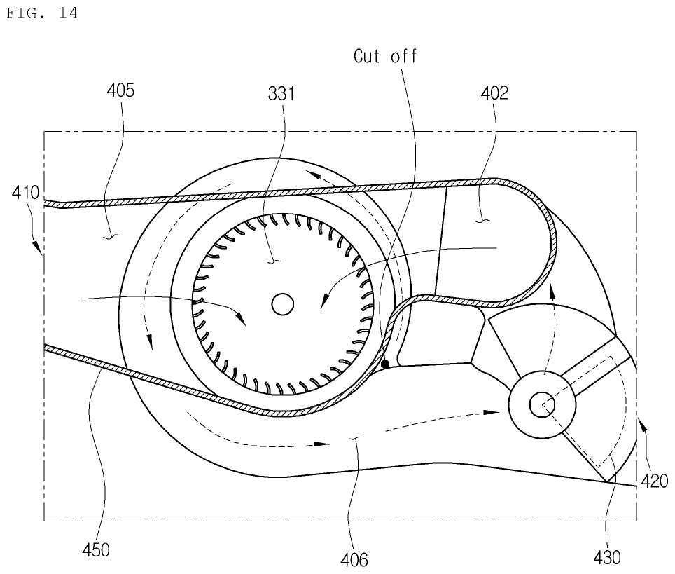

The return flow path 402 is disposed at the side of the blower inlet 331 close to a cut-off region of a scroll case 330, and is formed in a region that is not overlapped with the cut-off region. As illustrated in FIGS. 12 and 13, the cut-off region of the scroll case 330 is a cut portion of the scroll case 330 and is a point in which air is discharged from the blower wheel 310 in a spiral direction.

In addition, the air inflow port 410 is formed at the side of the blower inlet 331, and the inlet flow path 405 is formed to include a portion of the height of the scroll case 330. In the conventional air conditioner for a vehicle, even when the air inflow port is disposed on the front surface of the blower inlet or on the side surface of the blower inlet, the inlet flow path is located above the scroll case. The air conditioner 400 for a vehicle according to the embodiment of the present invention minimizes a height h3 of the air inflow port 410 and the air inflow path 410. That is, in the air conditioner 400 for the vehicle according to the present invention, the inlet flow path 405 is formed to an area including a portion of the height of the scroll case 330 to minimize the size of the blower 300 and secure the air volume as much as possible.

The return flow path 402 is formed not to overlap the cut-off region, so that air is smoothly introduced through the blower inlet 331 and the air discharged to the outlet flow path 406 through the blower outlet is not affected by the return flow path 402. In addition, the return flow path 402 is disposed at the side of the blower inlet 331, which is nearly cut off, so as to be arranged to face the air inflow port 410. Therefore, there is no interference between the air introduced to the blower inlet 331 after passing the inlet flow path 405 through the air inflow port 410 and the air introduced to the blower inlet 331 through the return flow path 402.

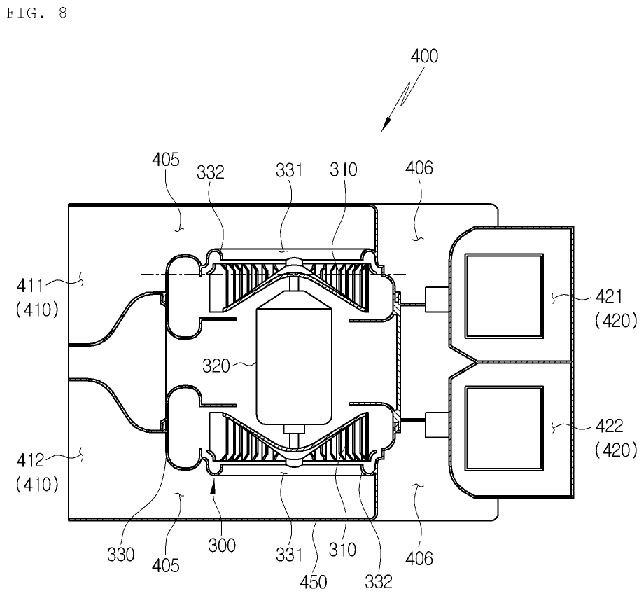

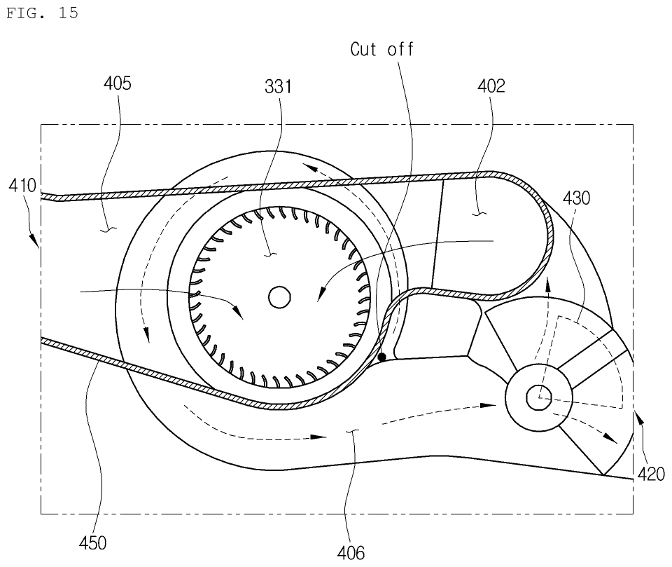

Moreover, the scroll case 330 on the side of the inlet flow path 405 is larger in area and height than the scroll case 330 on the side of the return flow path 402. As illustrated in FIGS. 8 and 14, the area of the scroll case 330 on the side of the inlet flow path 405 is larger than that of the scroll case 330 on the side of the return flow path 402. That is, the scroll case 330 on the side of the return flow path 402 is formed below an end of an inlet ring 332 of the blower inlet 331 and gradually expands in the air flow direction.

The return flow path 402 has a curved shape to provide a resistance so that the introduced air can be naturally introduced toward the blower wheels 310. If velocity of the introduced air is increased, the air passes through the blower wheel 310 and flows backwards to the return flow path 402. So, the inlet of the return flow path 402 is smaller than the air inflow port 410.

In addition, a partition wall 403 is formed between the return flow path 402 and the blower 300 to prevent the air re-suctioned to the blower 300 from being discharged. In order to prevent the air introduced to the blower 300 from flowing backward to the return flow path 402 and prevent generation of a vortex between the introduced air, the partition wall is formed in the air inflow direction. In order to maximize the above effect, the partition wall 403 protrudes further forward than the blower 300. In detail, since the partition wall 403 is formed to surround the blower 300, the blower 300 is disposed inside the partition wall 403.

Furthermore, the return flow path 402 further includes a guide having a step so that the returning air can be smoothly re-suctioned to the blower 300. That is, the guide 404 has a stepped structure in which the guide 404 is formed to be lower than the partition wall 403. In detail, the air returned through the guide 404 having the stepped structure can be suctioned to the blower 300 more smoothly than the air passing through the return flow path which does not have the guide having the stepped structure., and the stepped structure of the guide 404 helps to prevent generation of a vortex.

In more detail, stepped portions 355 and 356 are respectively formed in the inlet flow path 405 and the return flow path 402 to guide air to the blower inlet 331. That is, as described above, in order to secure the air volume as much as possible, the inlet flow path 405 and the turn flow path 402 include a portion of the height of the scroll case 330 and respectively have the stepped portions 355 and 356 for guiding air. If the air inflow port 410 is connected to the lower end of the scroll case 330 without such a stepped portion, air collides with the side surface of the scroll case 330 to generate a vortex. Therefore, in a case in which the air inflow port 410 is partially overlapped with the side of the scroll case 330, the stepped portion 355 and 356 must guide the air to the blower inlet 331.

In this case, the stepped portions 355 and 356 are formed between the heights of the scroll cases 330, and more preferably, the stepped portions 355 and 356 are formed in the middle of the height of the scroll case 330. That is, the stepped portions 355 and 356 are disposed within a percentage of ±15% of the middle of the scroll case 330 or disposed at the central portion of the scroll case when the scroll case is trisected. Through such a configuration, the air conditioner according to the present invention can smoothly guide the air to the blower inlet 311 without increasing the resistance of air, thereby making a smooth air flow.

The height of the stepped portion of the return flow path 402 is the same as the inlet flow path 405 of the air inflow port 410. In addition, the height of the scroll case 330 of the return flow path 402 is lower than that of the inlet ring 332 of the blower inlet 331. Accordingly, the air can smoothly flow to the blower inlet 331 through the return flow path 402.

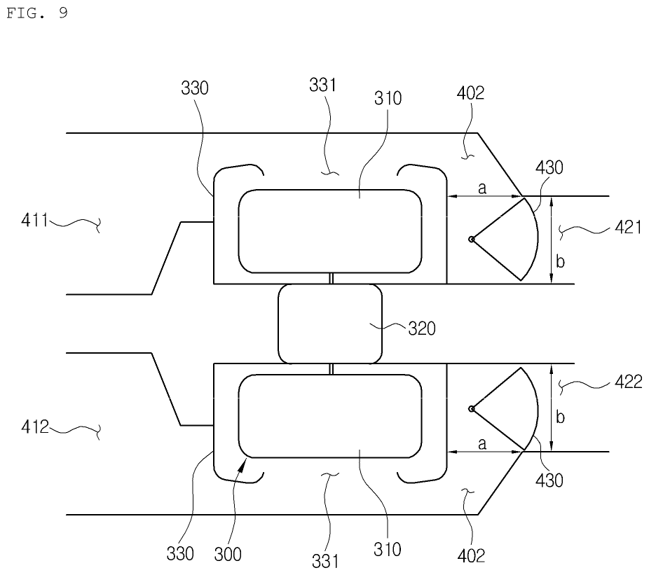

Furthermore, the air conditioner for a vehicle according to the present invention includes a communication portion 407 for connecting the blower outlet and the return flow path 402. In this case, an area of the communicating portion 407 is smaller than that of the air discharge port 420. That is, as illustrated in FIG. 9, the area A of the communication portion 407 is formed to be smaller than an area B of the air discharge port. Accordingly, in a case in which the return air volume control door 430 opens both the communication portion 407 and the air discharge port 420, the air passing through the outlet flow path 406 can be smoothly returned through the communication portion 407 by pressure.

The air conditioner for a vehicle according to the present invention includes a mode door 431 provided downstream of the return air volume control door 430 in the air flow direction. The mode door 431 adjusts the amount and direction of the air discharged to the air discharge port 420. Meanwhile, the return air volume control door 430 opens and closes the communication portion 407, and also opens and closes the air discharge port 420.

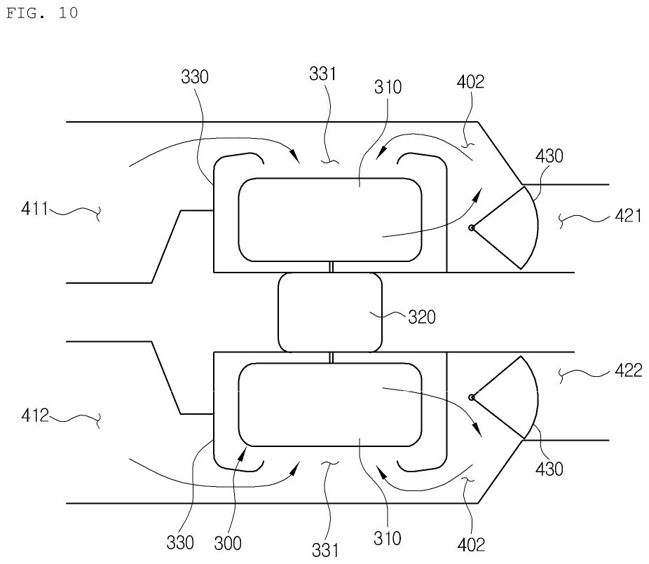

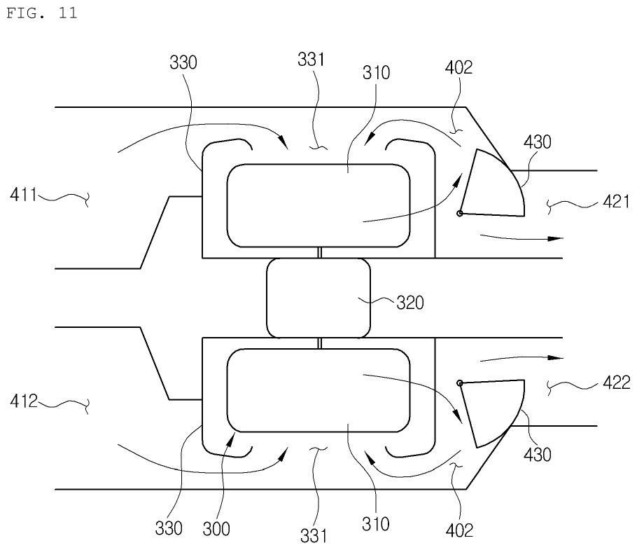

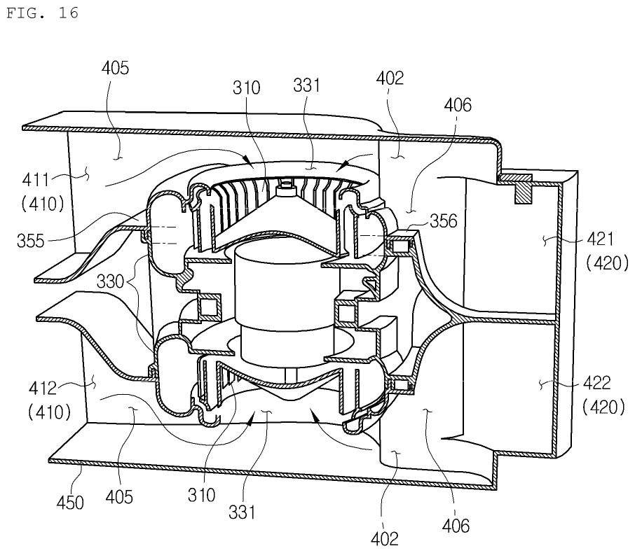

That is, as illustrated in FIGS. 10 and 14, the return air volume control door 430 of a dome shape completely closes the flow path directing the air discharge port 420 and completely opens only the communication portion 407, so that the entire air passing through the outlet flow path 406 can be returned to the return flow path 402 through the communication portion 407. Moreover, as illustrated in FIGS. 11 and 15, the return air volume control door 430 partially closes the air discharge port 420 and opens the communication portion 407 together, so that some of the air passing through the outlet flow path 406 can be always discharged to the air discharge port 420.

Meanwhile, the air inflow port 410 is connected to the front seat main air conditioner to increase the volume of the air discharged to the rear seat of the vehicle. That is, indoor air or outdoor air can be introduced through the air inflow port 410, the air inflow port 410 may be connected to the front seat main air conditioner to introduce air.

1. An air conditioner for a vehicle comprising:
a blower having a plurality of blower wheels and a blower motor for driving the plurality of blower wheels with the same power;
a plurality of inlet flow paths for connecting an air inflow port and a blower inlet with each other;
a plurality of outlet flow paths for connecting a blower outlet and an air discharge port with each other; and
a return flow path for returning at least a portion of the air discharged from the blower outlet to the blower inlet.

2. The vehicle air conditioner according to claim 1, wherein a return air volume control door for adjusting the air volume of the blower outlet supplied to the return flow path is disposed.

3. The vehicle air conditioner according to claim 1, wherein the return flow path is disposed at the side of the blower inlet close to a cut-off region of a scroll case, and is formed in a region that is not overlapped with the cut-off region.

4. The vehicle air conditioner according to claim 1, wherein the other scroll case on the side of the inlet flow path is larger in area and height than the scroll case on the side of the return flow path.

5. The vehicle air conditioner according to claim 1, wherein stepped portions for guiding air to the blower unit are respectively formed in the inlet flow path and the return flow path.

6. The vehicle air conditioner according to claim 5, wherein the stepped portion is formed between the heights of the scroll case.

7. The vehicle air conditioner according to claim 5, wherein the stepped portion is formed in the middle of the height of the scroll case.

8. The vehicle air conditioner according to claim 4, wherein the height of the scroll case on the side of the return flow path is formed to be lower than an end of an inlet ring of the blower inlet and is gradually increased in an air flow direction.

9. The vehicle air conditioner according to claim 2, wherein a communication portion for connecting the blower outlet and the return flow path, and an area of the communicating portion is smaller than that of the air discharge port.

10. The vehicle air conditioner according to claim 9, wherein the return air volume control door opens and closes the communication portion, and also opens and closes the air discharge port.

11. The vehicle air conditioner according to claim 2, wherein the return air volume control door partially closes the air discharge port so that a portion of the air is always discharged through the air discharge port.

12. The vehicle air conditioner according to claim 1, wherein the air inflow port is connected to a front seat main air conditioner to increase the volume of the air discharged to the rear seat of the vehicle.

13. The vehicle air conditioner according to claim 1, wherein the air inflow port is formed on the side of the blower inlet, and the inlet flow path includes a portion of the height of the scroll case.
